(19) United States
(12) Patent Application Publication
(10) Pub. No.: US 2025/0112378 A1
(43) Pub. Date: Apr. 3, 2025

(54) MULTI-BAND AND MULTI-FUNCTIONAL ANTENNA INTEGRATED MODULE AND PREPARATION METHOD THEREOF

(71) Applicant: INSTITUTE OF MICROELECTRONICS, CHINESE ACADEMY OF SCIENCES, Beijing (CN)

(72) Inventors: Haoran WANG, Beijing (CN); Tao ZHANG, Beijing (CN); Chongmei PENG, Beijing (CN); Zhaohui CHEN, Beijing (CN)

(73) Assignee: INSTITUTE OF MICROELECTRONICS, CHINESE ACADEMY OF SCIENCES, Beijing (CN)

(21) Appl. No.: 18/385,086

(22) Filed: Oct. 30, 2023

(30) Foreign Application Priority Data
Sep. 28, 2023 (CN) 202311280956.7

(51) Int. Cl. H01Q 15/00; H01Q 21/06

(52) U.S. Cl. CPC H01Q 15/0086; H01Q 21/065

(57) ABSTRACT

A multi-band and multi-functional antenna integrated module and a preparation method thereof are provided. The multi-band and multi-functional antenna integrated module has an electromagnetic wave capture layer, a frequency selection circuit layer, and a signal processing circuit layer stacked vertically in sequence. The frequency selection circuit layer and the frequency selection circuit layer are interconnected through a metallized through hole. The frequency selection circuit layer has a plurality of frequency selection circuit units with different processing bands. The signal processing circuit layer has a plurality of signal processing circuit units with different functions. The plurality of frequency selection circuit units are interconnected to the plurality of signal processing circuit units in a one-to-one correspondence manner through a plurality of metallized through holes.

### FIELD

The present invention relates to the field of integrated circuits, and in particular, to a multi-band and multi-functional antenna integrated module and a preparation method thereof.

### BACKGROUND

With the development of a communication technology, to achieve a leap from 5G to 6G and application of multiple input multiple output (MIMO) antennas to an emerging metasurface technology, modern communication systems often need to undertake multi-band and multi-functional high-complexity tasks. For example, signals of different bands need to be simultaneously reflected, transmitted, absorbed, and converted. Meanwhile, higher requirements are put forward for integration, modularization, and miniaturization. However, existing communication components are either of a single-band structure or a single-functional structure.

To this end, the present invention is proposed.

### SUMMARY

The present invention mainly aims to provide a multi-band and multi-functional antenna integrated module and a preparation method thereof, so as to solve the problem that a communication element has a single function.

To achieve the above objective, the present invention provides the following technical solutions.

A first aspect of the present invention provides a multi-band and multi-functional antenna integrated module, including an electromagnetic wave capture layer, a frequency selection circuit layer, and a signal processing circuit layer stacked vertically in sequence.

The frequency selection circuit layer and the frequency selection circuit layer are interconnected through a metallized through hole.

The frequency selection circuit layer includes a plurality of frequency selection circuit units with different processing bands, and the signal processing circuit layer includes a plurality of signal processing circuit units with different functions; and the plurality of frequency selection circuit units are interconnected to the plurality of signal processing circuit units in a one-to-one correspondence manner through a plurality of metallized through holes.

Therefore, the present invention connects the electromagnetic wave capture layer with a wideband electromagnetic wave signal capture function to the frequency selection circuit layer, and transmits signals of different bands to different signal processing circuit units of the signal processing circuit layer after the signals are processed by different frequency selection circuit units of the frequency selection circuit layer, thereby achieving different functions of different bands, including but not limited to reflection, transmission, absorption, and conversion of the signals. Therefore, the antenna integrated module of the present invention has the characteristics of multiple bands and multiple functions and can undertake high-complexity tasks. At the same time, the size of a radio frequency system can be further reduced to reduce transmission stop and increase the degree of integration.

Further, the electromagnetic wave capture layer includes a first base plate; an antenna structure layer is arranged on an upper surface of the first base plate; and a metal grounding layer is arranged on a lower surface of the first base plate.

The electromagnetic wave capture layer is configured to capture electromagnetic wave signals. The metal grounding layer is arranged on a back surface, which can improve the antenna signal receiving ability, also prevent static interference, and protect the safety of equipment. The antenna structure layer is isolated from the metal grounding layer through the first base plate, so that preparation is facilitated, and the functional layers on the upper and lower surfaces can be better isolated.

Further, the antenna structure layer includes a metasurface antenna structure.

As a metamaterial two-dimensional planar structure, a metasurface has advantages of low profile, simple design, low loss, and the like. Due to the characteristics of wide impedance bandwidth, high gain, and the like, the metasurface antenna structure is more advantageous in performance for communication devices. In practical products, it is possible to select whether to use a metasurface structure according to a functional need.

Further, the frequency selection circuit layer includes a second base plate; the metal grounding layer is stacked on an upper surface of the second base plate; and the frequency selection circuit units are arranged on a lower surface of the second base plate.

As the frequency selection circuit units are arranged on the lower surface of the second base plate, the second base plate can play a role of isolating the metal grounding layer from the frequency selection circuit units, without adding an additional insulation layer, which can make components lighter and thinner and save materials.

Further, the plurality of frequency selection circuit units include at least one of a low-pass filter, a bandpass filter, and a high-pass filter.

These filters are all of widely used filter structures, which can be adjusted according to requirements of a specific actual application situation.

Further, the antenna structure layer is interconnected to the frequency selection circuit layer through a metallized through hole penetrating through the first base plate and the metal grounding layer.

Further, the signal processing circuit layer includes a third base plate; an upper surface of the third base plate is connected to the frequency selection circuit units; and the signal processing circuit units are arranged on a lower surface of the third base plate.

As the signal processing circuit units are arranged on the lower surface of the third base plate, the third base plate can play a role of isolating the frequency selection circuit units from the signal processing circuit units, without adding an additional insulation layer, which can make components lighter and thinner and save materials.

Further, the plurality of signal processing circuit units include at least one of an absorptive resistor, a phase shifter, a chip for receiving a signal, and a circulator.

The absorptive resistor can be completely absorbed and depleted, thus achieving an electromagnetic stealth effect in the band. After the phase shifter provides a phase change to a signal of the band, a metasurface function can be achieved. The chip for receiving a signal can transmit the signal of the band to a backend for processing, and the entire module is equivalent to an antenna with a filtering and frequency selection function. The circulator can be regarded as a transceiver antenna module with a full duplex function in the band.

Further, the first base plate, the second base plate, and the third base plate each independently use at least one of a glass base plate, a printed circuit board (PCB) base plate, a ceramic base plate, or a flexible material base plate.

A second aspect of the present invention provides a preparation method of the antenna integrated module of the first aspect, including:

bonding the electromagnetic wave capture layer, the frequency selection circuit layer, and the signal processing circuit layer together.

Or, the following method is adopted for preparation:
performing deposition layer by layer in sequence, for example, first depositing and forming the electromagnetic wave capture layer, then depositing and forming the frequency selection circuit layer on a surface of the electromagnetic wave capture layer, and finally depositing and forming the signal processing circuit layer.

In summary, compared with the prior art, the present invention has the following technical effects.

The present invention connects the electromagnetic wave capture layer with a wideband electromagnetic wave signal capture function to the frequency selection circuit layer, and transmits signals of different bands to different signal processing circuit units of the signal processing circuit layer after the signals are processed by different frequency selection circuit units of the frequency selection circuit layer, thereby achieving different functions of different bands, including but not limited to reflection, transmission, absorption, and conversion of the signals. The present invention provides a design of a multi-band and multi-functional metasurface and antenna hybrid module, so as to provide a feasible solution for various complex application scenarios in the future.

### BRIEF DESCRIPTION OF THE DRAWINGS

Various other advantages and benefits will become apparent to those of ordinary skill in the art upon reading the following detailed description of the preferred implementations. The accompanying drawings are only for the purpose of illustrating preferred implementations and are not considered as a limitation on the present invention.

FIG. 1 is a schematic exploded diagram of an antenna integrated module according to the present invention;

FIG. 2 is a schematic overall diagram of an antenna integrated module according to the present invention;

FIG. 3 is a structural top view of an electromagnetic wave capture layer;

FIG. 4 is a bottom view of a frequency selection circuit layer; and

FIG. 5 is a bottom view of a signal processing circuit layer.

### REFERENCE NUMERALS IN THE DRAWINGS

101: electromagnetic wave capture layer; 102: frequency selection circuit layer; 103: signal processing circuit layer;
201: antenna structure layer; 202: first base plate; 203: second base plate; 204: third base plate; 205: metallized through hole; 206: metal grounding layer; 207: frequency selection circuit unit; 208: metallized through hole; 209: signal processing circuit unit; 401: filter structure; 402: filter structure; 403: filter structure; 404: filter structure; 501: absorptive resistor; 502: phase shifter; 503: chip for receiving a signal; and 504: circulator.

### DETAILED DESCRIPTION

The embodiments of the present disclosure will be described below with reference to the accompanying drawings. However, it should be understood that these descriptions are only illustrative and not intended to limit the scope of the present disclosure. In addition, in the following explanation, descriptions of well-known structures and techniques have been omitted to avoid unnecessary confusion with the concepts of the present disclosure.

Various schematic structural diagrams according to the embodiments of the present disclosure are shown in the accompanying drawings. These drawings are not drawn to scale. For the purpose of clarity, some details have been enlarged, and some details may possibly have been omitted. Shapes of various regions and layers shown in the drawings, as well as their relative sizes and positional relationships, are only exemplary. In practice, there may be deviations due to manufacturing tolerances or technical limitations. In addition, a person skilled in the art can additionally design regions/layers with different shapes, sizes, and relative positions according to actual needs.

In the context of the present disclosure, when a layer/component is referred to as being located “above” another layer/component, the layer/component can be directly located on another layer/component, or there can be an intermediate layer/component between them. In addition, if a layer/component is located “above” another layer/component in a certain orientation, when the orientation is reversed, the layer/component can be located “below” another layer/component.

Existing communication components have a single function. For example, antennas and filters are usually designed independently. When applied to a system, the antennas and filters need to be interconnected through additional transmission lines, and additional circuit components are required for matching between devices. This type of product occupies a large space.

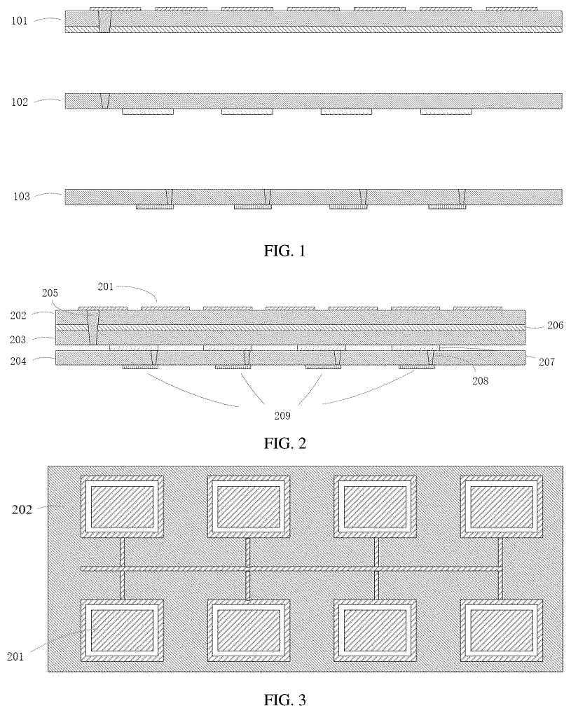

To this end, the present invention provides an antenna integrated module as shown in FIG. 1 to FIG. 2, which has the characteristics of multiple bands and multiple functions. Specifically, the antenna integrated module includes an electromagnetic wave capture layer 101, a frequency selection circuit layer 102, and a signal processing circuit layer 103 stacked vertically in sequence, wherein the frequency selection circuit layer 102 and the frequency selection circuit layer 102 are interconnected through a metallized through hole 205.

The frequency selection circuit layer 102 includes a plurality of frequency selection circuit units 207 with different processing bands, and the signal processing circuit layer 103 includes a plurality of signal processing circuit units 209 with different functions. The plurality of frequency selection circuit units 207 are interconnected to the plurality of signal processing circuit units 209 in a one-to-one correspondence manner through a plurality of metallized through holes 208.

Therefore, the present invention connects the electromagnetic wave capture layer 101 with a wideband electromagnetic wave signal capture function to the frequency selection circuit layer 102, and transmits signals of different bands to different signal processing circuit units 209 of the signal processing circuit layer 103 after the signals are processed by different frequency selection circuit units 207 of the frequency selection circuit layer 102, thereby achieving different functions of different bands, including but not limited to reflection, transmission, absorption, and conversion of the signals.

The electromagnetic wave capture layer 101 can include a first base plate 202; an antenna structure layer 201 is arranged on an upper surface of the first base plate 202; and a metal grounding layer 206 is arranged on a lower surface of the first base plate 202. The electromagnetic wave capture layer 101 is configured to capture electromagnetic wave signals. The metal grounding layer 206 is arranged on a back surface, which can improve the antenna signal receiving ability, also prevent static interference, and protect the safety of equipment. The antenna structure layer 201 is isolated from the metal grounding layer 206 through the first base plate 202, so that preparation is facilitated, and the functional layers on the upper and lower surfaces can be better isolated. The antenna structure layer 201 can also adopt a metasurface antenna structure, for example, a metasurface antenna array structure in a 2×4 rectangular patch form as shown in FIG. 3. Each patch unit uses a gap structure, which expands a working bandwidth. In practical applications, specific sizes are determined according to a frequency, a bandwidth, and the like.

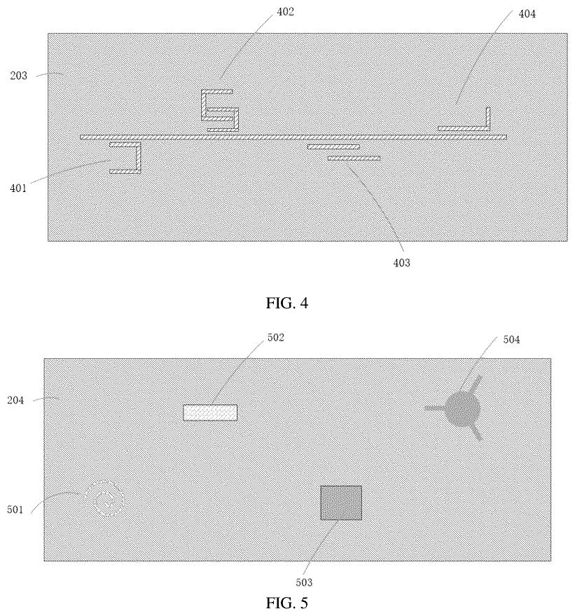

The frequency selection circuit layer 102 can include a second base plate 203; the metal grounding layer 206 is stacked on an upper surface of the second base plate 203; and the frequency selection circuit units 207 are arranged on a lower surface of the second base plate 203. Connection to the frequency selection circuit layer 102 is achieved through the metallized through hole penetrating through the first base plate 202, the metal grounding layer 206, and the second base plate 203. FIG. 4 shows a view of the frequency selection circuit layer 102. The plurality of frequency selection circuit units 207, namely, various coupled filter structures, include a filter structure 401, a filter structure 402, a filter structure 403, and a filter structure 404. These structures can be low-pass filters, bandpass filters, high-pass filters, and the like. They can be structures in various forms according to requirements of a specific actual application situation to meet different band requirements.

The signal processing circuit layer 103 can include a third base plate 204; an upper surface of the third base plate 204 is connected to the frequency selection circuit units 207; and the signal processing circuit units 209 are arranged on a lower surface of the third base plate 204. Electromagnetic signals subjected to frequency division performed by the frequency selection circuit layer 102 are connected to different signal processing circuit units 209 in a one-to-one correspondence manner through the several metallized through holes 208 of the third base plate 204. FIG. 5 shows a state of the signal processing circuit layer 103. The signal processing circuit units 209 have different functions according to different bands, and may include an absorptive resistor 501, a phase shifter 502, a chip 503 for receiving a signal, and a circulator 504. Due to the absorptive resistor 501, the electromagnetic wave signals in the band will be completely absorbed and depleted, thus achieving an electromagnetic stealth effect in the band. The phase shifter 502 can be a reflective microstrip phase shifter or an adjustable phase shifter, which can achieve a metasurface function after providing a phase change for the signal of the band. The chip 503 for receiving a signal can transmit the signal of the band to a backend for processing. The entire module is equivalent to an antenna with a filtering and frequency selection function. The frequency selection circuit unit 207 is connected to one port of the circulator 504, and can be regarded as a transceiver antenna module with a full duplex function in the band. The multiple functions achieved by the module depend on a signal processing function connected.

The first base plate 202, the second base plate 203, and the third base plate 204 which are adopted by the above three functional layers each independently use at least one of a glass base plate, a PCB base plate, a ceramic base plate, or a flexible material base plate.

There are various preparation methods of the antenna integrated module described above, for example, including: bonding the electromagnetic wave capture layer, the frequency selection circuit layer, and the signal processing circuit layer together;

or, performing deposition layer by layer in sequence, for example, first depositing and forming the electromagnetic wave capture layer, then depositing and forming the frequency selection circuit layer on a surface of the electromagnetic wave capture layer, and finally depositing and forming the signal processing circuit layer.

The above describes the embodiments of the present disclosure. However, these embodiments are for an illustration purpose only and are not intended to limit the scope of the present disclosure. The scope of the present disclosure is defined by the accompanying claims and their equivalents. A person skilled in the art can make various substitutions and modifications without departing from the scope of the present disclosure, and these substitutions and modifications should all fall within the scope of the present disclosure.

What is claimed is:

1. A multi-band and multi-functional antenna integrated module, comprising:
an electromagnetic wave capture layer,
a frequency selection circuit layer, and
a signal processing circuit layer stacked vertically in sequence,
wherein:
the frequency selection circuit layer and the frequency selection circuit layer are interconnected through a metallized through hole;
the frequency selection circuit layer comprises a plurality of frequency selection circuit units with different processing bands, and the signal processing circuit layer comprises a plurality of signal processing circuit units with different functions; and
the plurality of frequency selection circuit units are interconnected to the plurality of signal processing circuit units in a one-to-one correspondence manner through a plurality of metallized through holes.

2. The antenna integrated module according to claim 1, wherein the electromagnetic wave capture layer comprises a first base plate; an antenna structure layer is arranged on an upper surface of the first base plate; and a metal grounding layer is arranged on a lower surface of the first base plate.

3. The antenna integrated module according to claim 2, wherein the antenna structure layer comprises a metasurface antenna structure.

4. The antenna integrated module according to claim 2, wherein the frequency selection circuit layer comprises a second base plate; the metal grounding layer is stacked on an upper surface of the second base plate; and the frequency selection circuit units are arranged on a lower surface of the second base plate.

5. The antenna integrated module according to claim 1, wherein the plurality of frequency selection circuit units comprise at least one of a low-pass filter, a bandpass filter, and a high-pass filter.

6. The antenna integrated module according to claim 2, wherein the antenna structure layer is interconnected to the frequency selection circuit layer through a metallized through hole penetrating through the first base plate and the metal grounding layer.

7. The antenna integrated module according to claim 4, wherein the signal processing circuit layer comprises a third base plate; an upper surface of the third base plate is connected to the frequency selection circuit units; and the signal processing circuit units are arranged on a lower surface of the third base plate.

8. The antenna integrated module according to claim 1, wherein the plurality of signal processing circuit units comprise at least one of an absorptive resistor, a phase shifter, a chip for receiving a signal, and a circulator.

9. The antenna integrated module according to claim 7, wherein the first base plate, the second base plate, and the third base plate each independently use at least one of a glass base plate, a printed circuit board (PCB) base plate, a ceramic base plate, or a flexible material base plate.

10. A preparation method of the antenna integrated module according to claim 1, comprising:
bonding the electromagnetic wave capture layer, the frequency selection circuit layer, and the signal processing circuit layer together.
